(19) United States
(12) Patent Application Publication
(10) Pub. No.: US 2023/0130163 A1
(43) Pub. Date: Apr. 27, 2023

(54) PROJECT PULSE FEATURE, REQUIREMENT COMPLETION PULSE FEATURE, PROJECT OVERVIEW SYSTEM, PROJECT PLANNING SYSTEM, PROJECT MANAGEMENT SYSTEM, TASK MANAGEMENT AND ENHANCED UNDERSTANDING AND OVERVIEW SYSTEM, AND METHODS OF USE

(71) Applicant: Tieren Zhou, Burlingame, CA (US)

(72) Inventor: Tieren Zhou, Burlingame, CA (US)

(21) Appl. No.: 17/668,303

(22) Filed: Feb. 9, 2022

Related U.S. Application Data
(60) Provisional application No. 63/147,845, filed on Feb. 10, 2021.

(51) Int. Cl. G06Q 10/10; G06Q 10/1091; G06Q 10/1093

(52) U.S. Cl. CPC G06Q 10/103; G06Q 10/1091; G06Q 10/1097

(57) ABSTRACT

A project pulse display for a project overview system, project planning system, project management system, task management and enhanced understanding system, and methods of use are presented. The present system provides for improved project planning, project management, and unique tools, features, functionality, and components associated with project planning and project management. The present system introduces a roadmap planning methodology and visual assistant pulses which increase the success and efficiency in project planning. Particularly, this functionality provides for an improved ability for a user to quickly understand the status of a project, the current workings of a project, and understand other factors such as completion percentage and estimated deadline. Additionally, this system helps a user immediately understand if more resources and/or requirements might be needed on a particular project and/or task. Furthermore, this functionality assists a user for immediate understanding and management of traditional agile backlog planning.

### CROSS-REFERENCE TO RELATED APPLICATIONS

The present application claims priority to the U.S. Provisional Patent Application No. 63/147,845 which was filed on Feb. 10, 2021, which is hereby incorporated by reference herein in its entirety, including any figures, tables, or drawings.

### FIELD OF THE DISCLOSURE

This disclosure relates to a project pulse feature for providing automated feedback on completion percentages of tasks and/or requirements for a project and/or task. Said another way, the requirement pulse relates to and corresponds as a feature to the project overview system, project planning system, project management system, task management and enhanced understanding system, and methods of use. More specifically, and without limitation, this disclosure relates to a platform system which provides for project planning. More specifically, and without limitation, this disclosure relates to a roadmap planning system with visual references, support mechanisms which allow a manager or other to have a pulse, or unique understanding and overview of projects and tasks. Furthermore, and without limitation, this disclosure relates to project planning, organizing and updating project requirements, organizing and sharing project specifications, real-time progress updating and viewing, and the like, and related methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Kloud Inc. All rights reserved.

### BACKGROUND OF THE DISCLOSURE

Project management and organization has been a challenge for business owners, project managers, and others around the globe since organizing and collaboration began. Project management is a very complex and arduous task that requires most, if not all of the time of those trying to manage a project. Project management is the process of leading a team through work to achieve various goals and/or meet production success at a designated time. Project management usually involves various constraints that come with the goals the given team is trying to complete. These constraints are usually provided to the team through various documents, messages, communications, and other materials created by the team and/or project manager and/or project management team during planning and throughout the execution of the project or projects. Scope, time, and budget constraints are often therefore hard to achieve in organizing any project and successfully applying the project management needed, let alone viewing the various ongoing tasks and efforts during the project. For this reason, project management is very difficult, and oftentimes, impossible.

Project planning is part of project management. Project planning often involves the use of various types of schedules, and may even include a Gantt chart to plan and subsequently report progress within a project environment. Project planning often includes developing a project scope and outline the appropriate methods for completing the project. In some cases this also includes start and finish dates, outlining when the start of a project should begin and conclude. In many of these circumstances, project start dates and end dates often change, which can create problems, headaches, and overall derail a project completely. This makes project planning very difficult for all parties involved.

Furthermore, project planning is known as how those involved organize different aspects of a project. In known art, such as Gantt charts, this involves arranging some parts of the project with start dates that begin as another matter's end date, or strategically overlapping the start dates and end dates of various matters. This logical dependency of project planning often involves complex activity network diagramming and various critical paths that must be taken and/or critical steps that must be completed in the project planning process before others can begin. Making sure that these critical paths are adhered to, understanding where various matters are, and keeping track of critical paths and diagrams can grow extremely complex very quickly and makes it hard, or impossible is some cases, for project managers or organizers, and/or the parties involved to track a project and know what to do, especially if action is needed.

Some have tried to mitigate the damage of the complexities and derailments that happen in project planning by providing weighted averages of tasks or matters. In other words, those involved assign probabilities that a matter will be completed on time, started on time, or completed over with terminology like optimistic, normal, or pessimistic, or weightedly optimistic, and the like.

Gantt charts are sometimes used to assist with project planning. Gantt charts are a type of bar chart which are attempts to illustrate a project's schedule to a viewer. In Gantt charts, bars are laid horizontally and align with various start and end dates. The best and most modernized Gantt charts may also show dependencies. In this way, and in Gantt charts, various tasks may be able to relay to a viewer what projects need to be completed before another can start. Oftentimes a project manager does not know if a task and/or matter is completed, what the progress is on any task or matter, or whether the next matter can begin. This complicates the effectiveness of any project greatly.

Thus, it is a primary object of this disclosure to provide a project overview system, project planning system, project management system, task management and enhanced understanding system, and methods of use which solves many of these long existing problems in the art. Furthermore, it is a primary object of this disclosure to provide a project overview system, project planning system, project management system, task management and enhanced understanding system, and methods of use that makes project management easier, more effective, and more efficient for project managers.

Furthermore, it is a primary object of this disclosure to provide a project overview system, project planning system, project management system, task management and enhanced understanding system, and methods of use that makes project management and organization easier, more effective, and more efficient for the various parties and/or stakeholders involved in a project and/or complex projects.

Additionally, and said another way, an object of this disclosure is to solve many long-felt needs plaguing the art of project management. Said another way, project management, and particularly project managers have wasted a lot of time in attempting to manage projects and when it comes to managing complex projects, many project managers fail to understand and/or have a feel of where projects are at and what other undertakings might be needed.

In this way, and as another object of this disclosure, the present disclosure provides the state of the art with a project overview system, project planning system, project management system, task management and enhanced understanding system, and methods of use that provides project managers and others with the ability to better understand the current status of a project, the current status of various aspects of various projects, and have a better understanding of productivity, more flexibility in goals and timelines and the, and have a better feel for which team members are productive and more. In this way, the present disclosure improves the ability of a project manager and team members involved to manage a project, better schedule, and improve the overall efficiency of any operation. Similarly, in this way, the balance of matters can be better achieved and understood including the overall well-being, mental health, and even physical health of the various parties involved.

### SUMMARY OF THE DISCLOSURE

This disclosure relates to a project pulse feature for providing automated feedback on completion percentages of tasks and/or requirements for a project and/or task. Said another way, the requirement pulse relates to and corresponds as a feature to the project overview system, project planning system, project management system, task management and enhanced understanding system, and methods of use which are presented. More specifically, and without limitation, the project pulse and/or requirement pulse features disclosed herein correspond to or are the percentage finish of a requirement—the requirement showing historic, current, and/or future. The pulse requirement, in this example, represents the visualization of the progression of completion, or percentage finish, when a user selects different days and/or different time frames. The project overview system, project planning system, project management system, task management and enhanced understanding system, and methods of use solve many of these long existing problems in the art and to provide a more flexible, respectful, efficient, and clearly understood project management system which benefits businesses, employees, and customers.

Thus, the present disclosure provides a project overview system, project planning system, project management system, task management and enhanced understanding system, and methods of use introducing roadmap planning with visual assistant pulses. These project pulses allow teams to better plan projects. Furthermore, the project pulses and other disclosures herein consistently enhance traditional agile backlog planning in a much more user friendly, easy to understand way.

In one example, the present disclosure does provide for traditional Gantt formatting, this is primarily provided for the benefit of a user who is familiar with Gantt charts. In this way, however, in a different manner than traditionally known in the art, and in an opposite direction of methods and tools developed, the present disclosure does not use start dates and end dates. Start dates and end dates are not accurate, typically end up changed, and cause tremendous confusion in a project. This limits the capabilities and can cause more problems than it solves in traditional system.

Instead, the present disclosure eliminates these start and end dates. In this way, the present disclosure, in one example, introduces to the state of the art a roadmap concept. The roadmap concept introduced in the project overview system, project planning system, project management system, task management and enhanced understanding system, and methods of use provides for assignment of various requirements. Similarly, the roadmap concept introduced in an example herein, in the project overview system, project planning system, project management system, task management and enhanced understanding system, and methods of use provides for assigning specifications. Similarly, the roadmap concept introduced in an example herein, in the project overview system, project planning system, project management system, task management and enhanced understanding system, and methods of use provides for assigning features of the project, task, and the like.

Said another way, requirements of a project and/or matter are committed within a roadmap month. This roadmap concept eliminates the need for start dates and end dates which have so long plagued the state of the art. In one example, a default setting can be to break the roadmap concept into months. The roadmap concept can be broken down into days, hours, a period of days, a period of months, or even an annual basis depending on the project size and parameters. In the example (as is further discussed herein) the roadmap concept broken down in this way can align with more agile planning for project managers and team members.

In this arrangement, and in the example, herein, once the roadmap is broken into applicable time chunks, a user and/or manager can (in the backlog view or requirement view) assign various requirements to the roadmap chunks and/or roadmap portions. Similarly, once the roadmap is broken into applicable time chunks, a user and/or manager can (in the backlog view or requirement view) assign various defects to the roadmap chunks and/or roadmap portions.

In another example, the present disclosure can display to a user actual real time progress using the project pulses; a feature that will be demonstrated more thoroughly in the specification and accompanying materials. The requirement pulse feature (further discussed herein), can be generated via the implementation module (also further discussed herein). In this way, the present disclosure is capable of breaking down modules that need to be completed in order for the work to be finished. This makes the project management much simpler for the manager and those involved. Similarly, this makes assigning the broken down module easier because the system also helps with assignment, as will be shown by example herein.

In this way, the present disclosure provides for a means of quantifying the size of a requirement, the implementation of executing that requirement, and the effort involved in completing a requirement. The present disclosure provides these features while creating an easy to view interface for a project manager so that an entire month, or quarter, or other roadmap period can be clearly conceptualized.

Thus, it is a primary object of the disclosure to provide a project overview system, project planning system, project management system, task management and enhanced understanding system, and methods of use that introduces a roadmapping and visual requirement pulse functionality which allow teams to project plan in an enhanced way as never available before.

In other words, it is a primary object of the disclosure to provide a project overview system, project planning system, project management system, task management and enhanced understanding system, and methods of use that solves long felt needs in the project management art by providing unique solutions, unique features, unique functionalities, and the like which make project management and project planning easy to understand, grasp, share, and more.

Another object of the disclosure is to provide a project overview system, project planning system, project management system, task management and enhanced understanding system, and methods of use that provides for agile project management.

Yet another object of the disclosure is to provide a project overview system, project planning system, project management system, task management and enhanced understanding system, and methods of use that provides for agile project planning.

Another object of the disclosure is to provide a project overview system, project planning system, project management system, task management and enhanced understanding system, and methods of use that provides for agile planning in software development.

Yet another object of the disclosure is to provide a project overview system, project planning system, project management system, task management and enhanced understanding system, and methods of use that provides for agile planning in software projects.

Another object of the disclosure is to provide a project overview system, project planning system, project management system, task management and enhanced understanding system, and methods of use that provide for the ability to project plan without start dates.

Yet another object of the disclosure is to provide a project overview system, project planning system, project management system, task management and enhanced understanding system, and methods of use that provide for the ability to project plan without end dates.

Another object of the disclosure is to provide a project overview system, project planning system, project management system, task management and enhanced understanding system, and methods of use that provide the ability to make changes to project scheduling with ease.

Yet another object of the disclosure is to provide a project overview system, project planning system, project management system, task management and enhanced understanding system, and methods of use that provide a roadmap feature.

Another object of the disclosure is to provide a project overview system, project planning system, project management system, task management and enhanced understanding system, and methods of use that provide a visual requirement pulse which enables understanding in a project manager.

Yet another object of the disclosure is to provide a project overview system, project planning system, project management system, task management and enhanced understanding system, and methods of use that provide a visual requirement pulse which enables understanding for a team.

Another object of the disclosure is to provide a project overview system, project planning system, project management system, task management and enhanced understanding system, and methods of use that provide the ability to view an entire project using Gantt.

Yet another object of the disclosure is to provide a project overview system, project planning system, project management system, task management and enhanced understanding system, and methods of use that provide the ability to assign requirements to a roadmap block (portion of time).

Another object of the disclosure is to provide a project overview system, project planning system, project management system, task management and enhanced understanding system, and methods of use that provide the ability to assign a specification and/or specific information to a roadmap block (portion of time).

Yet another object of the disclosure is to provide a project overview system, project planning system, project management system, task management and enhanced understanding system, and methods of use that provide the ability to assign a feature and/or features to a roadmap block.

Another object of the disclosure is to provide a project overview system, project planning system, project management system, task management and enhanced understanding system, and methods of use that displays actual real time progress to a user.

Yet another object of the disclosure is to provide a project overview system, project planning system, project management system, task management and enhanced understanding system, and methods of use that eliminates the need for start dates in planning.

Another object of the disclosure is to provide a project overview system, project planning system, project management system, task management and enhanced understanding system, and methods of use that eliminates the need for end dates in planning.

Yet another object of the disclosure is to provide a project overview system, project planning system, project management system, task management and enhanced understanding system, and methods of use that provide a requirement pulse feature.

Another object of the disclosure is to provide a project overview system, project planning system, project management system, task management and enhanced understanding system, and methods of use that provide a requirement pulse feature that enables a manager to have an overall feel and understanding of the state of various tasks.

Yet another object of the disclosure is to provide a project overview system, project planning system, project management system, task management and enhanced understanding system, and methods of use that provide a requirement pulse and/or project pulse feature that enables a manager and/or user to have an overall feel and understanding of the state of various projects.

Another object of the disclosure is to provide a project overview system, project planning system, project management system, task management and enhanced understanding system, and methods of use that can generate the pulse directly from the implementation module.

Yet another object of the disclosure is to provide a project overview system, project planning system, project management system, task management and enhanced understanding system, and methods of use that breaks down project requirements into modules that need to be completed.

Another object of the disclosure is to provide a project overview system, project planning system, project management system, task management and enhanced understanding system, and methods of use that breaks down project requirements into modules that need to be completed in order for the requirement to finish.

Yet another object of the disclosure is to provide a project overview system, project planning system, project management system, task management and enhanced understanding system, and methods of use that further breaks modules down to tasks.

Another object of the disclosure is to provide a project overview system, project planning system, project management system, task management and enhanced understanding system, and methods of use that further assigns tasks to developers and/or an implementer so the module can be completed and so that a user and/or implementer knows who is assigned to complete the task.

Yet another object of the disclosure is to provide a project overview system, project planning system, project management system, task management and enhanced understanding system, and methods of use that is available to a user via a web platform.

Another object of the disclosure is to provide a project overview system, project planning system, project management system, task management and enhanced understanding system, and methods of use that can be viewed and interacted with by a user via a mobile application.

Yet another object of the disclosure is to provide a project overview system, project planning system, project management system, task management and enhanced understanding system, and methods of use that can be viewed and interacted with by a user via a windows application.

Another object of the disclosure is to provide a project overview system, project planning system, project management system, task management and enhanced understanding system, and methods of use that can quantify requirements independently.

Yet another object of the disclosure is to provide a project overview system, project planning system, project management system, task management and enhanced understanding system, and methods of use that can quantify the size of the requirement implementation effort for each module independently of team tasks.

Another object of the disclosure is to provide a project overview system, project planning system, project management system, task management and enhanced understanding system, and methods of use that provides a point system for quantifying.

Yet another object of the disclosure is to provide a project overview system, project planning system, project management system, task management and enhanced understanding system, and methods of use that provide a point system for quantifying time spent and/or time required for a module, task, and/or project.

Another object of the disclosure is to provide a project overview system, project planning system, project management system, task management and enhanced understanding system, and methods of use that can assign points from the point system to each module independent of task.

Yet another object of the disclosure is to provide a project overview system, project planning system, project management system, task management and enhanced understanding system, and methods of use that can assign points from the point system to each module independent of teams to implement.

Another object of the disclosure is to provide a project overview system, project planning system, project management system, task management and enhanced understanding system, and methods of use that provide for spec points to vary from task points, instead of as a summation of total tasks.

Yet another object of the disclosure is to provide a project overview system, project planning system, project management system, task management and enhanced understanding system, and methods of use that provide business drivers and/or managers and/or users with the power and flexibility to drive a team.

Another object of the disclosure is to provide a project overview system, project planning system, project management system, task management and enhanced understanding system, and methods of use that can calculate the spec point percentage finished.

Yet another object of the disclosure is to provide a project overview system, project planning system, project management system, task management and enhanced understanding system, and methods of use that provide a percentage of module, task, and/or project completion based on a spec point calculation determined from a teams hourly, daily, weekly, monthly, quarterly, yearly basis; a combination thereof and the like.

Another object of the disclosure is to provide a project overview system, project planning system, project management system, task management and enhanced understanding system, and methods of use that provide for a manager and/or user to visualize the daily percentage finish for each module.

Yet another object of the disclosure is to provide a project overview system, project planning system, project management system, task management and enhanced understanding system, and methods of use that provide for a manager and/or user to visualize the daily percentage finish for each module and/or for the entire requirement based on the module points and the percentage finish.

Another object of the disclosure is to provide a project overview system, project planning system, project management system, task management and enhanced understanding system, and methods of use that provides a calculated percentage progress and displays this progress to a manager and/or user based on task's daily time spent and time remaining and weighted by module points.

Yet another object of the disclosure is to provide a project overview system, project planning system, project management system, task management and enhanced understanding system, and methods of use that provide projections and history of how a requirement will and has progressed.

Another object of the disclosure is to provide a project overview system, project planning system, project management system, task management and enhanced understanding system, and methods of use that eliminates the need to drill down into tasks and/or “micro manage” by seeing team's actual daily progress at the requirement level and/or business value level.

Yet another object of the disclosure is to provide a project overview system, project planning system, project management system, task management and enhanced understanding system, and methods of use that provide a means for a manager and/or user to view the entire project from the requirement view point.

Another object of the disclosure is to provide a project overview system, project planning system, project management system, task management and enhanced understanding system, and methods of use that provide a percentage finish column for each requirement which conveys to a user the current hour, day, week, month, quarterly, yearly, or the like percentage finish.

Yet another object of the disclosure is to provide a project overview system, project planning system, project management system, task management and enhanced understanding system, and methods of use that provide various color organization to indicate different meanings to a user.

Another object of the disclosure is to provide a project overview system, project planning system, project management system, task management and enhanced understanding system, and methods of use that provide the ability to visualize in real-time, actual progress.

Yet another object of the disclosure is to provide a project overview system, project planning system, project management system, task management and enhanced understanding system, and methods of use that provide a dynamic, no change management requirement, and can generate other features such as comparing baselines and showing how the module, task, or project deviated from original plans and/or deviated from similar or like-structured plans.

Another object of the disclosure is to provide a project overview system, project planning system, project management system, task management and enhanced understanding system, and methods of use that incorporate a traditional Gantt view.

Yet another object of the disclosure is to provide a project overview system, project planning system, project management system, task management and enhanced understanding system, and methods of use that can prioritize by roadmap months.

Another object of the disclosure is to provide a project overview system, project planning system, project management system, task management and enhanced understanding system, and methods of use that provide various display layers to a user and/or manager including a roadmap month which shows requirements committed to be finished, requirement percentage finished and/or completed which shows progress of children tasks and module points, and also shows a requirement pulse via projected or historic—which includes a real time progress tracker—showing past activity and future projected activity for a selected day.

Yet another object of the disclosure is to provide a project overview system, project planning system, project management system, task management and enhanced understanding system, and methods of use that provide visualizations for overall project by actual, not estimated, not by start/end dates, and enhances agile backlog planning.

Another object of the disclosure is to provide a project overview system, project planning system, project management system, task management and enhanced understanding system, and methods of use that provide for the time estimate to be completed independently of the project implementation details.

Yet another object of the disclosure is to provide a project overview system, project planning system, project management system, task management and enhanced understanding system, and methods of use that provide an improved and easier to understand the amount of work required for each requirement.

Another object of the disclosure is to provide a project overview system, project planning system, project management system, task management and enhanced understanding system, and methods of use that provide for managers and/or stake holders and/ur users to estimate the project cost independently of the project implementation teams, to be inhouse or to be outsourced.

Yet another object of the disclosure is to provide a project overview system, project planning system, project management system, task management and enhanced understanding system, and methods of use that provide a balance between the business value-based project total cost estimates versus the engineering based cost estimates.

Another object of the disclosure is to provide a project overview system, project planning system, project management system, task management and enhanced understanding system, and methods of use that improves upon the state of the art.

Yet another object of the disclosure is to provide a project overview system, project planning system, project management system, task management and enhanced understanding system, and methods of use that improves upon the state of the art by providing a more effective means of roadmap planning.

Another object of the disclosure is to provide a project overview system, project planning system, project management system, task management and enhanced understanding system, and methods of use that improves upon the state of the art by providing a more vivid and accurate project progress animation; which provide a user with how a project is actually implemented.

Yet another object of the disclosure is to provide a project overview system, project planning system, project management system, task management and enhanced understanding system, and methods of use that are optimized and/or compatible with smartphone technology.

Another object of the disclosure is to provide a project overview system, project planning system, project management system, task management and enhanced understanding system, and methods of use that provide machine learning.

Yet another object of the disclosure is to provide a project overview system, project planning system, project management system, task management and enhanced understanding system, and methods of use that are efficient.

Another object of the disclosure is to provide a project overview system, project planning system, project management system, task management and enhanced understanding system, and methods of use that are easy to use.

Yet another object of the disclosure is to provide a project overview system, project planning system, project management system, task management and enhanced understanding system, and methods of use that are robust.

Another object of the disclosure is to provide a project overview system, project planning system, project management system, task management and enhanced understanding system, and methods of use that saves time.

Yet another object of the disclosure is to provide a project overview system, project planning system, project management system, task management and enhanced understanding system, and methods of use that are user friendly.

Another object of the disclosure is to provide a project overview system, project planning system, project management system, task management and enhanced understanding system, and methods of use that can be implemented by teams easily.

Yet another object of the disclosure is to provide a project overview system, project planning system, project management system, task management and enhanced understanding system, and methods of use that can be used by a variety of users.

These and other objects, features, or advantages of the present disclosure will become apparent from the specification and claims.

### BRIEF DESCRIPTION OF THE DRAWINGS

FIG. 1 is a diagram illustrating the project overview system, project planning system, project management system, task management and enhanced understanding system, and methods of use.

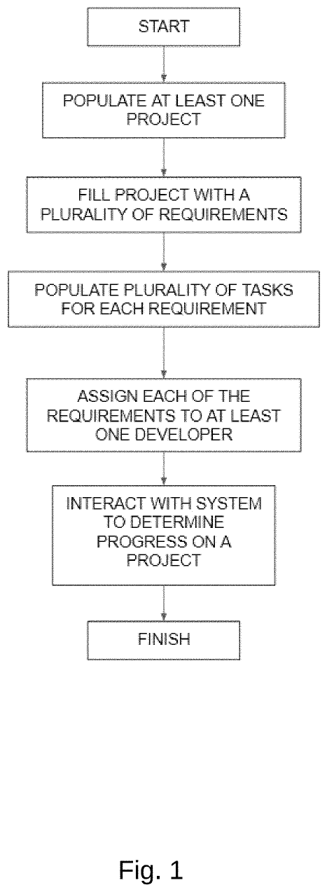

FIG. 2 is a diagram illustrating the project overview system, project planning system, project management system, task management and enhanced understanding system, and methods of use; the view showing the system in association with a user and platform and tasks.

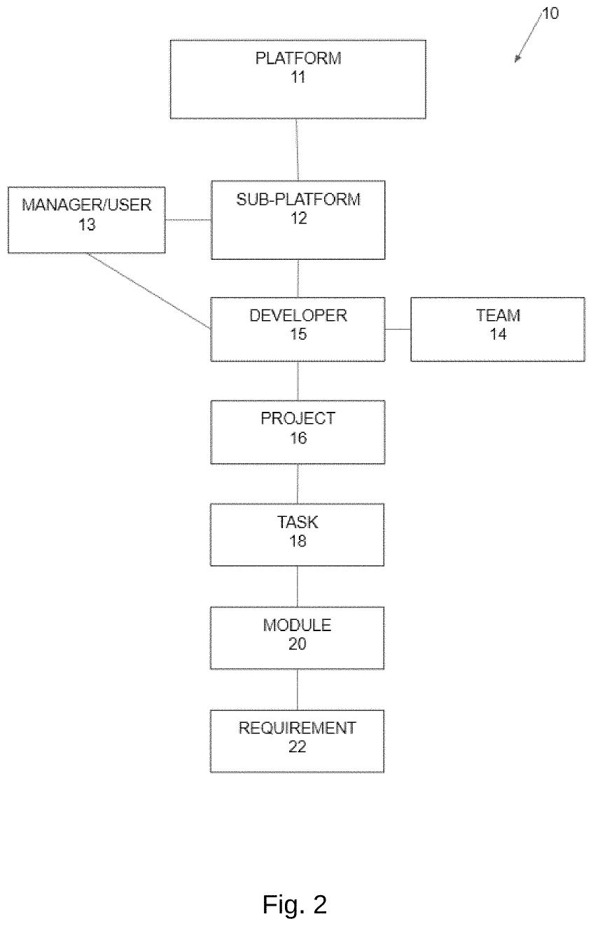

FIG. 3 is a diagram illustrating the project overview system, project planning system, project management system, task management and enhanced understanding system, and methods of use; the view showing computing platform information related to the system, including a computer system and some interactions.

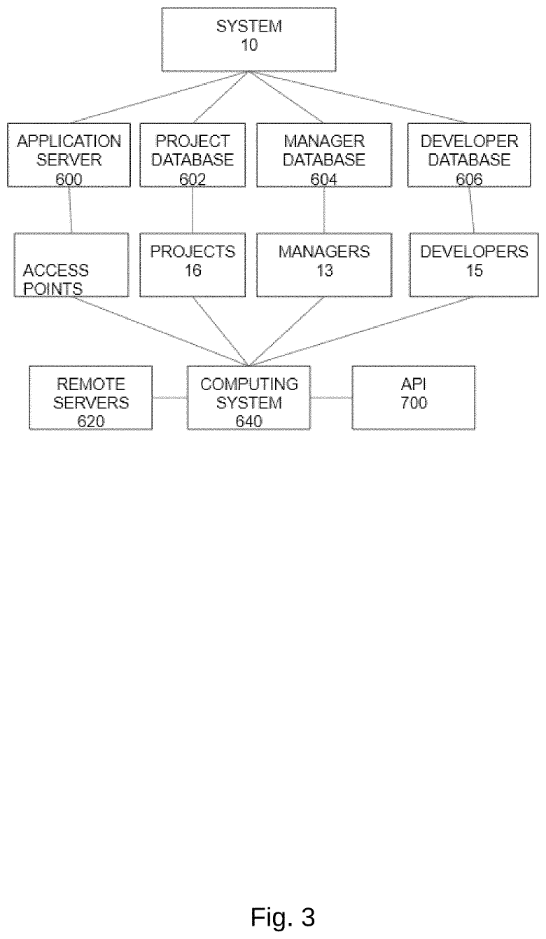

FIG. 4 is a diagram illustrating the project overview system, project planning system, project management system, task management and enhanced understanding system, and methods of use; the view showing a user interface; the view showing pages associated with the user interface.

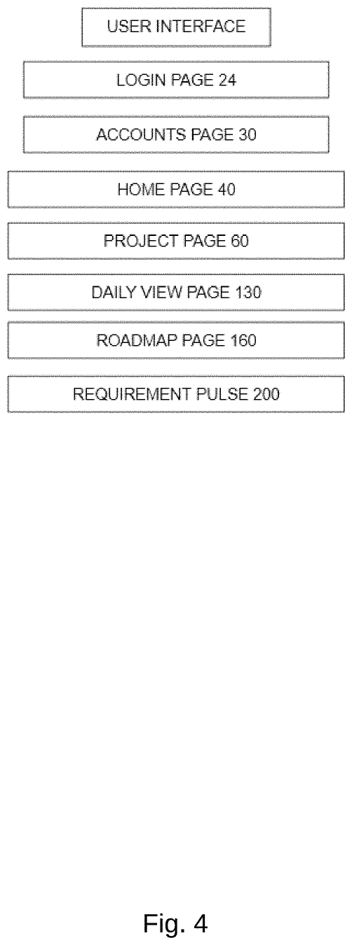

FIG. 5 is a diagram illustrating the project overview system, project planning system, project management system, task management and enhanced understanding system, and methods of use; the view showing a user interface; the view showing a login page feature.

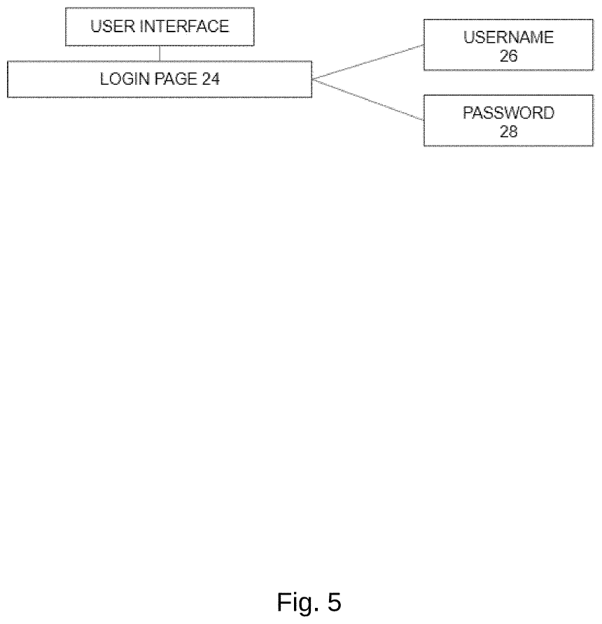

FIG. 6 is a diagram illustrating the project overview system, project planning system, project management system, task management and enhanced understanding system, and methods of use; the view showing a user interface; the view showing an accounts page.

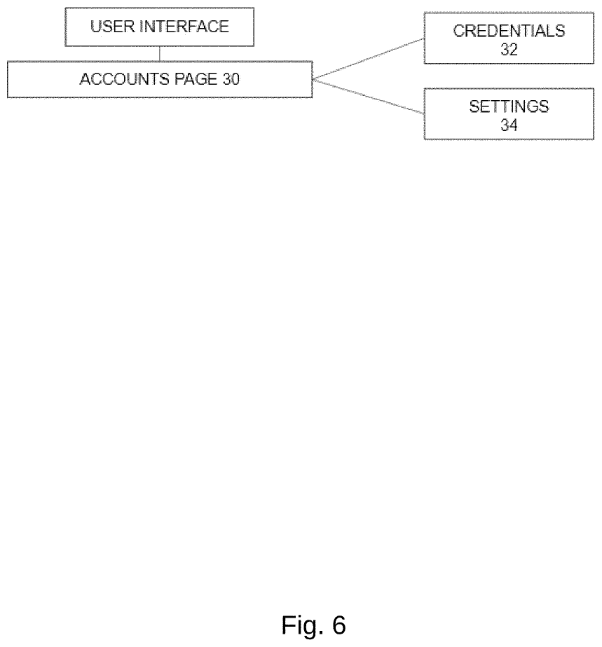

FIG. 7 is a diagram illustrating the project overview system, project planning system, project management system, task management and enhanced understanding system, and methods of use; the view showing a user interface; the view showing a home page and various features associated with a home page or system.

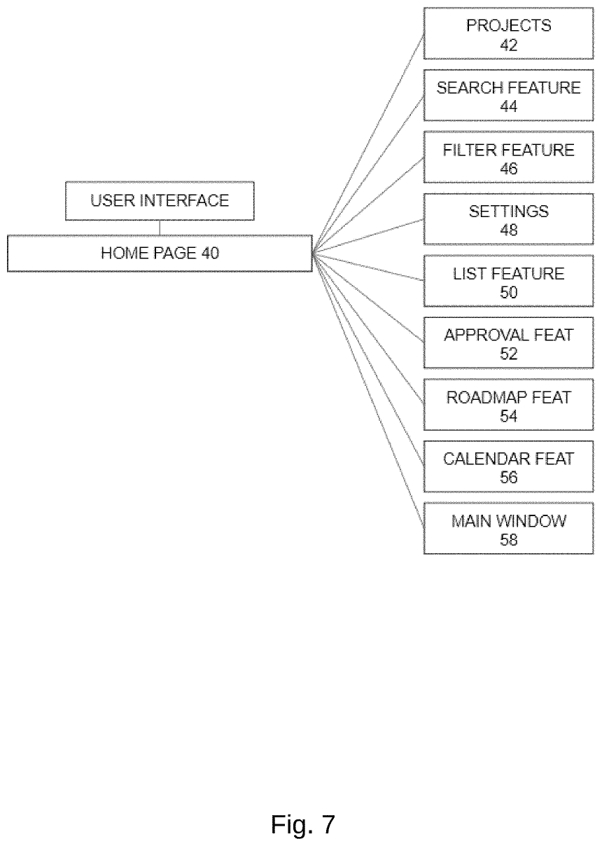

FIG. 8 is a diagram illustrating the project overview system, project planning system, project management system, task management and enhanced understanding system, and methods of use; the view showing a user interface; the view showing a project page and various features associated with the project page.

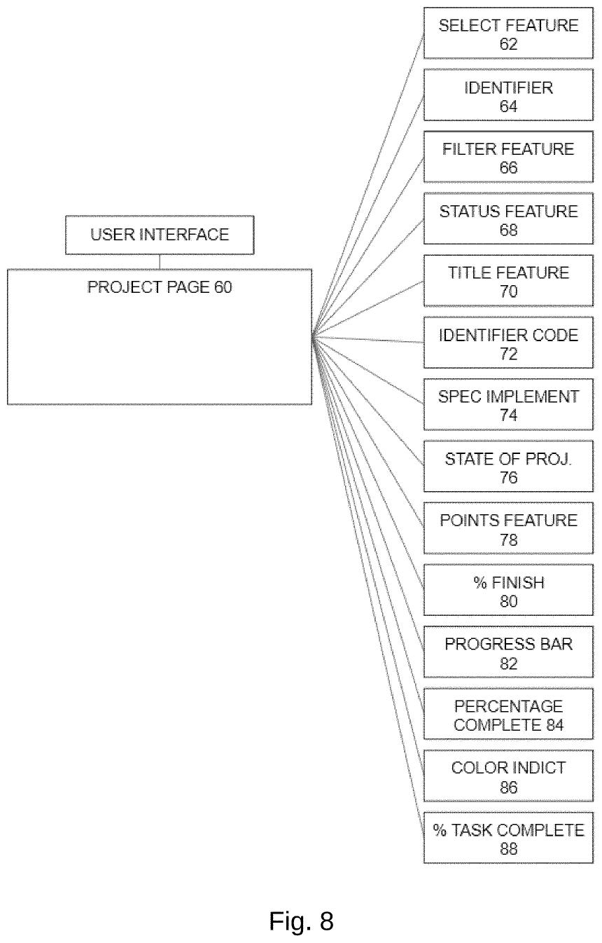

FIG. 9 is a diagram illustrating the project overview system, project planning system, project management system, task management and enhanced understanding system, and methods of use; the view showing a user interface; the view showing a project page and various features associated with the project page.

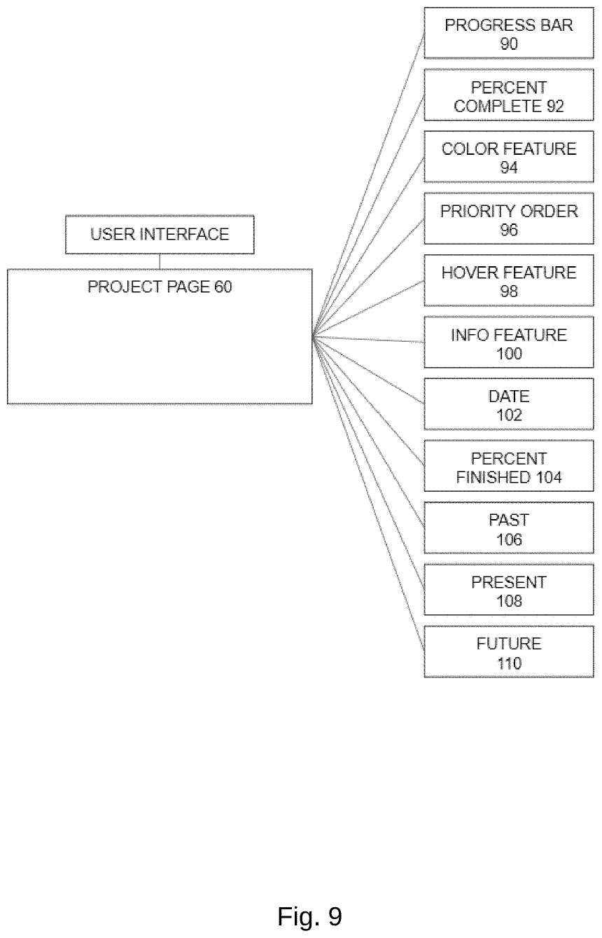

FIG. 10 is a diagram illustrating the project overview system, project planning system, project management system, task management and enhanced understanding system, and methods of use; the view showing a user interface; the view showing a project page and various features associated with the project page.

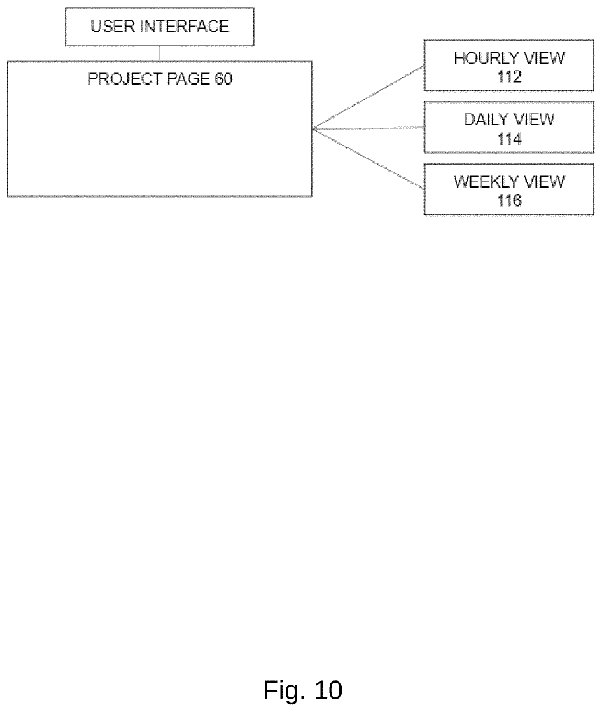

FIG. 11 is a diagram illustrating the project overview system, project planning system, project management system, task management and enhanced understanding system, and methods of use; the view showing a user interface; the view showing a project page and various features associated with the project page.

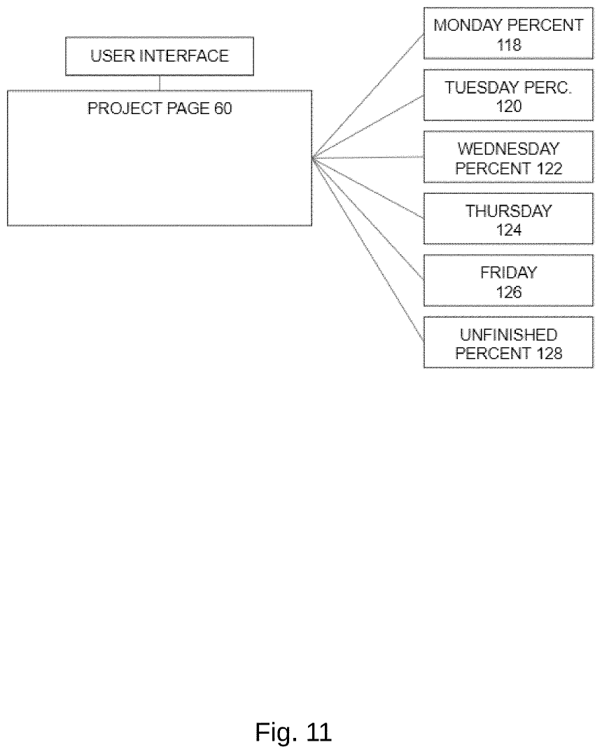

FIG. 12 is a diagram illustrating the project overview system, project planning system, project management system, task management and enhanced understanding system, and methods of use; the view showing a user interface; the view showing a daily view page and various features associated with the daily view page.

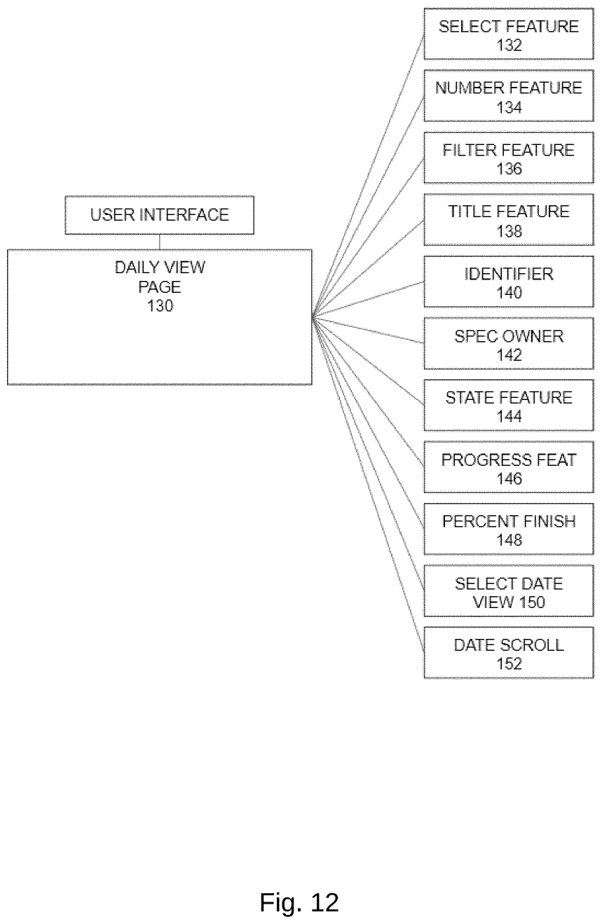

FIG. 13 is a diagram illustrating the project overview system, project planning system, project management system, task management and enhanced understanding system, and methods of use; the view showing a user interface; the view showing a roadmap page feature and various features associated with the roadmap page.

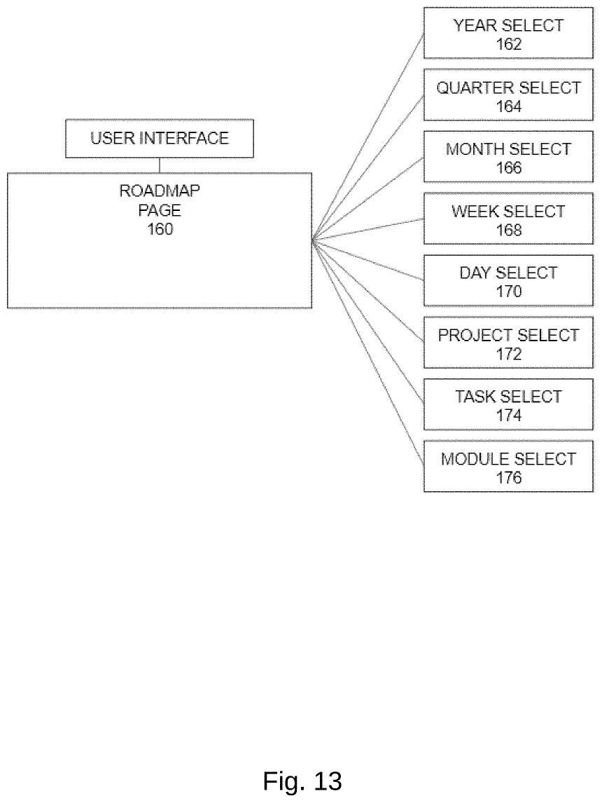

FIG. 14 is a diagram illustrating the project overview system, project planning system, project management system, task management and enhanced understanding system, and methods of use; the view showing a user interface; the view showing a requirement pulse and various features and parameters associated with the requirement pulse.

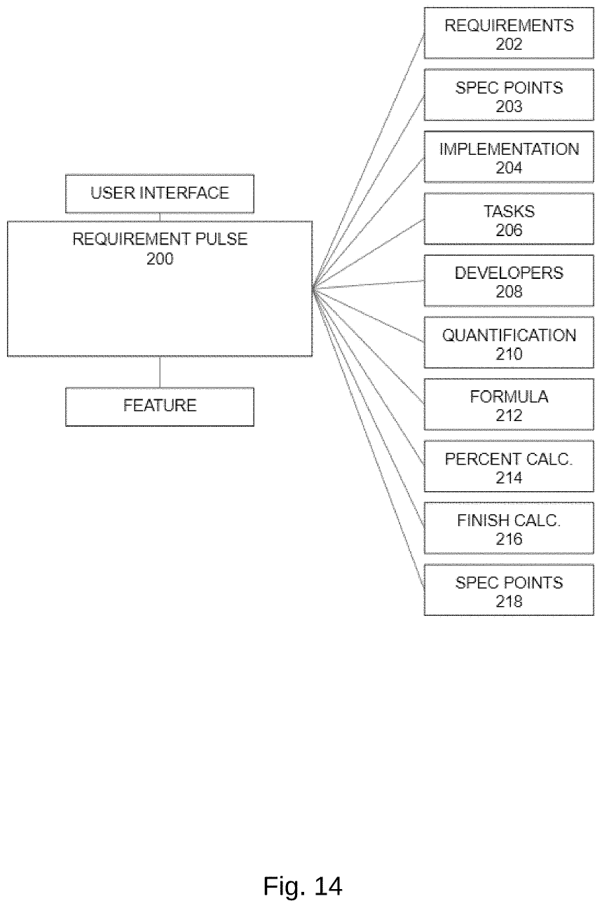

FIG. 15 is a diagram illustrating the requirement flow for the requirement, workload assessment, and task assignment and tracking; the view showing an example of the system.

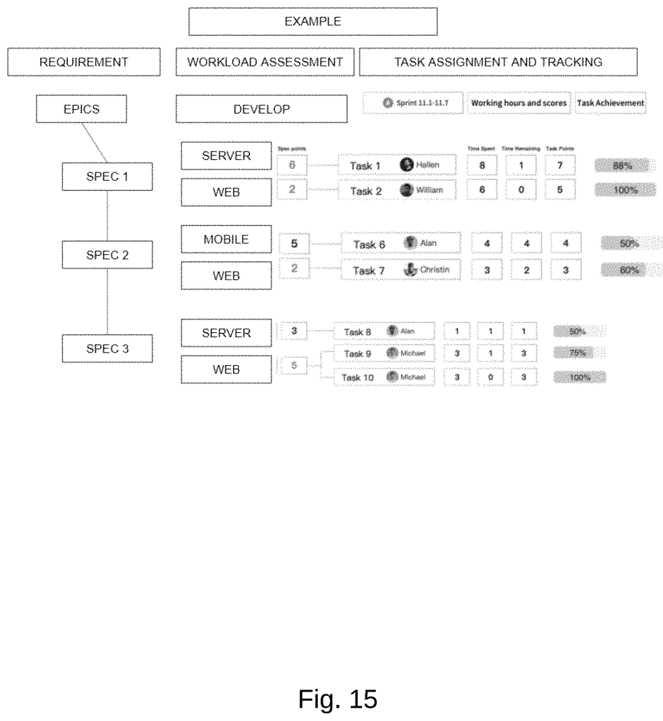

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The present disclosure provides the state of the art with a new feature and/or functionality related to project planning. Said another way, and without limitation, the present disclosure provides the state of the art with a project pulse, or requirement pulse, feature which provides a project manager with a completion percentage of a particular task and/or a particular requirement and/or a particular project. Furthermore, the present disclosure updates this completion percentage—for easy viewing—which provides updates to this completion percentage automatically and/or at an interval which follows a predetermined set of rules. Said another way, this disclosure relates to a project pulse feature for providing automated feedback on completion percentages of tasks and/or requirements for a project and/or task. Said another way, the requirement pulse relates to and corresponds as a feature of the overall project overview system, project planning system, project management system, task management and enhanced understanding system, and methods of use may be formed of any suitable user interface, shape, design, and features. The project overview system, project planning system, project management system, task management and enhanced understanding system, and methods of use, disclosed herein, solve many long existing problems in the art and to provide a more flexible, respectful, efficient, and clearly understood project management system which benefits businesses, employees, and customers. These features, functionality, among customization features and many other unique features are presented herein, and by example, herein through a particular interface.

The present disclosure provides a project overview system, project planning system, project management system, task management and enhanced understanding system, and methods of use which introduces roadmap planning with visual assistant pulses to the project management art field. These project pulses allow teams to better plan projects, and plan projects in a way not seen in the art prior to this disclosure. Furthermore, the project pulses and other disclosures herein consistently enhance traditional agile backlog planning in a much more user friendly, easy to understand way.

In one example, and as presented herein, the present disclosure does provide for traditional Gantt formatting, this is primarily provided for the benefit of a user who is familiar with Gantt charts. In this way, however, in a different manner than traditionally known in the art, and in an opposite direction of methods and tools developed, the present disclosure does not use start dates and end dates. The elimination of start dates and end dates would be contrary to any typical project planning. However, start dates and end dates are problematic for many reasons; start dates and end dates are not accurate, typically end up changed, and cause tremendous confusion in a project. In project planning and or management, this limits the capabilities of a team and can cause more problems than it solves.

Instead, the present disclosure eliminates start and end dates. In this way, the present disclosure, in one example, introduces to the state of the art a roadmap concept. The roadmap concept introduced in the project overview system, project planning system, project management system, task management and enhanced understanding system, and methods of use provides for assignment of various requirements. Similarly, the roadmap concept introduced in an example herein, in the project overview system, project planning system, project management system, task management and enhanced understanding system, and methods of use provides for assigning specifications. Similarly, the roadmap concept introduced in an example herein, in the project overview system, project planning system, project management system, task management and enhanced understanding system, and methods of use provides for assigning features of the project, task, and the like.

Said another way, requirements of a project and/or matter are committed within a roadmap month. This roadmap concept eliminates the need for start dates and end dates which have so long plagued the state of the art. In one example, a default setting can be to break the roadmap concept into months. The roadmap concept can be broken down into days, hours, a period of days, a period of months, or even an annual basis depending on the project size and parameters. In the example (as is further discussed herein) the roadmap concept broken down in this way can align with more agile planning for project managers and team members.

In this arrangement, and in the example, herein, once the roadmap is broken into applicable time chunks, a user and/or manager can (in the backlog view or requirement view) assign various requirements to the roadmap chunks and/or roadmap portions. Similarly, once the roadmap is broken into applicable time chunks, a user and/or manager can (in the backlog view or requirement view) assign various defects to the roadmap chunks and/or roadmap portions.

In another example, the present disclosure can display to a user actual real time progress using the project pulses; a feature that will be demonstrated more thoroughly in the specification and accompanying materials. The requirement pulse feature (further discussed herein), can be generated via the implementation module (also further discussed herein). In this way, the present disclosure is capable of breaking down modules that need to be completed in order for the work to be finished. This makes the project management much simpler for the manager and those involved. Similarly, this makes assigning the broken down module easier because the system also helps with assignment, as will be shown by example herein.

In this way, the present disclosure provides for a means of quantifying the size of a requirement, the implementation of executing that requirement, and the effort involved in completing a requirement. The present disclosure provides these features while creating an easy to view interface for a project manager so that an entire month, or quarter, or other roadmap period can be clearly conceptualized. These and other features and functionalities are disclosed further in the disclosure herein and following sections.

System:

With reference to the figures, a project overview system, project planning system, project management system, task management and enhanced understanding system, and methods of use 10 are presented (hereafter known as “project management system”, “project planning system”, “project overview system”, “project pulse platform”, “task management platform”, “pulse system”, or “requirement pulse”, or simply “platform”, or simply “system”). Project management system 10 is formed of any suitable size, shape and design and may comprise various components, platforms, features, and functionalities.

In the arrangement shown, as one example, pulse system 10 is configured to ease and/or make easy to understand the planning, status, and future scheduling needs of a project. Particularly, the project pulse or requirement pulse 10 is configured to provide a quick view and automatically updated completion percentage. The present disclosure relates directly to any project planning, however, many examples discuss software projects as may be especially conducive to the benefits of the disclosure herein.

Furthermore, and as in the arrangement shown, the pulse system 10 provides the state of the art with and is configured to introduce a new means of project planning and/or project management through roadmap planning. In this way, the present disclosure provides a means of visualizing the requirement pulses (to be further discussed herein), which allows teams to plan out projects while enhancing and staying consistent.

Furthermore, and in the arrangement shown herein, pulse system 10 is configured to show a manager and/or user actual real time progress on a requirement of a task, project, and the like. The present disclosure provides various features which enable a user to track and manage projects and plan projects which include various roadmapping features (as further discussed herein) and requirement features, and pulse features.

In the arrangement shown, as one example, project planning system 10, which may comprise remote servers, databases, application servers, application databases, product databases, mobile applications, merchant databases, customer databases, developer databases, networking application servers, and/or computers that fulfill the functions disclosed herein, also includes, in the embodiment(s) depicted by example which includes, but is not limited to a platform 11, a sub-platform 12, a project team 13, a manager and/or user 14, a developer and/or implementer 15, a project 16, a task 18, a module 20, a requirement 22, a login page 24, an accounts page 30, a home page 40, a project page 60, a view page 130, a roadmap page 160, and a requirement pulse 200, among other components, features, and functionalities.

In the arrangement shown, as one example, system 10 comprises remote servers, databases, and/or computers that fulfill the functions disclosed and described herein. The appearance of the presentation of project information and/or developer information and/or task information and/or the process windows for uploading and/or adding information to the pulse system and or retrieving and/or displaying information and/or other data transactions related to the system 10 may vary. Furthermore, in the arrangement shown, as one example, and only for the purpose of being an example, the roadmap features are discussed. The primary focus of this patent application for the project pulse feature, but through the context of the overall project planning system further disclosed—including roadmapping and the various ways of mapping out projects, tasks, requirements, and the like.

Platform:

In the arrangement shown, as one example, project pulse system 10 includes a platform 11. Platform 11 (also known as “processing system”, and “graphical user interface”) is formed of any suitable size shape and design and is configured to provide a user and/or manager and/or developer to view various project information, planning, access various projects, access various tasks, access various modules, access various requirements, invite others to join a project and/or task, earn rewards, view progress, and the like, and view other information related thereto, and/or view various parties involved and/or view various documents and/or manage assignments and/or manage people and/or get a feel of the overall process, progress, and team assignments for management purposes and the like.

Graphical user interface 11 is an exemplary method by which systems of the present disclosure may be accessed and interacted with. Additionally, graphical user interface 11 provides the functionality and may provide scannable codes, live monitoring, live interaction systems, video conferencing, and direct synchronization of information through cellular and/or other connections.

In the arrangement shown, as one example, graphical user interface 11 includes various pages, windows, and the like. In the arrangement shown, as one example, processing system 11 may include a sub-platform (also known as “sub-systems”) 12, includes a login page 24, an accounts page 30, may also include a landing page, includes a project page 60, a view page 130—which may be an hourly view page, a daily view page, a weekly view page, a bi-weekly view page, a monthly view page, a quarterly view page, a year view page, a combination thereof, and the like—and also includes a roadmap page 160, among other features, components, pages, and functionalities.

Sub-Platform:

In one embodiment, and in the arrangement shown, as one example, system 10 includes a sub-platform 12 (also known as “sub-processing system”, “interaction system”, or simply “network system”). Networking system 12 is formed of any suitable size, shape, and design and is configured to provide various networking and/or interactions amongst groups and/or teams and/or users (to be further discussed herein).

In the arrangement shown, as one example, the sub-platform system 12 provides an interaction between managers, managers and team members, team members, and others. In this way, the team members can interact, coordinate, plan, share screens, and the like. In this way, sub-system 12 provides various systems integrated into system 10 which may provide for interactions ranging from video conferencing to background processing features that enable the various functionalities and features of system 10. In this way, sub-system 12 is not limited to an interaction system but includes various sub-processing systems.

These and other systems are contemplated for use and will be discussed in further detail in the disclosure herein.

Users:

Manager: In the arrangement shown, as one example, system 10 includes a plurality of managers 13 (also known as a “coordinator”, or “planner”, or “owner”). Owner 13 may be any project manager which is to be engaged with system 10. In the arrangement shown, as one example, a manager 13 is the primary person in charge of the coordination, organization, and seeing through that a project gets completed. In this way the manager 13 is the primary person interacting with the system and making decisions based on system 10 observations and systems feedback. A manager 13 may be a business owner, a project manager, a team leader, a combination, thereof, and the like.

Project Team: In the arrangement shown, as one example, system 10 includes a project team 14 (also known as a “team” or “team members”). Team members 14 may be any person, entity, and/or user which is to be engaged with the system 10 and/or engages with the project and/or coordinates to assist in project completion by direct and/or indirect use of the system 10. In this way, a team member 14 engages with and is responsible for an aspect of a project or providing input to help get a project completed.

Implementer: In the arrangement shown, as one example, system 10 includes a plurality of users 15. User 15 is typically a user engaging with and/or utilizing system 10. Said another way, a user 15 is a user, typically, engaging with the graphical user interface 11 and/or visiting a page within the system 10 and/or providing and/or production services for task completion and/or services for the project manager to help in completion of a project and/or a developer helping in the development of a software, and the like. In the arrangement shown, as one example, an implementer 15 may be referred to a team member or production specialist and the like.

Project:

In the arrangement shown, as one example, system 10 includes a project 16. Project 16 (also known as “matter”) is formed of any suitable size, shape, and design and is any project that a team and/or individual is wishing to complete. Projects by nature have a broad definition as projects vary in goals, types, and who might be involved and what the duration of a project might be. In the arrangement shown, as one example, a project 16 may also be referred to as a program 16 and/or software program 16.

Task: In the arrangement shown, as one example, project 16 includes a plurality of tasks 18. Plurality of tasks 18 includes various smaller items and/or a breakdown of items which need to be completed as a sequence and/or grouping of smaller items which make up an overall project and/or plurality of projects.

Module: In the arrangement shown, as one example, project 16 may also include a plurality of modules 20. Plurality of modules 20 includes various smaller items and/or a breakdown of items which need to be completed as a sequence and/or grouping of smaller items which make up an overall task and/or plurality of tasks. In the arrangement shown, as one example, a module 20 may also be considered a smaller component of a larger software program, which when combined with other modules, achieves a goal of the software program and/or other goals.

Requirement: In the arrangement shown, as one example, project 16 may be broken down further into a plurality of requirements 22. Plurality of requirements 22 includes various smaller items and/or a breakdown of items which need to be completed as a sequence and/or grouping of smaller items which make up an overall task and/or plurality of modules 20.

In the arrangement shown, as one example, a requirement 22 is broken further down into various roadmapping features. This important component of the larger functionality of system 10 is discussed further herein.

Login Page:

In the arrangement shown, as one example, graphical user interface 11 includes a login page 24 (also known as “sign-in page” or “landing page”). Login page 24 is generally the landing page which a user is first directed to so that a user can login, change profiles or select from other quick navigation options. Additionally, a create account page 24 is also available to a user.

In the arrangement shown, as one example, landing page 24 includes, but is not limited to a username 26, a password 28, a slogan, a logo, a name feature, a second slogan feature, a waiting screen, and a home page link, a return feature, an image feature, an identifier tab, a title, a more information feature, a menu feature, among other features, components, and functionality.

Accounts Page:

In the arrangement shown, as one example, graphical user interface 11 includes an accounts page 30 (also known as “profile page”). Accounts page 30 is formed of any suitable size, shape, and design and is configured to provide for changing settings, reviewing information, reviewing information about the platform, registering others, registering team members, registering teams, registering projects, and the like associated with a user's profile.

In the arrangement shown, as one example, profile page 30 includes, but is not limited to, credentials 32 and settings 34, and may also include a profile picture, a profile name, a plurality of settings, a switch to business mode feature, a manage notifications feature, a profile information feature, a privacy and terms feature 39, an open platform settings feature, a frequently asked questions section, among other features, components, and functionalities.

Home Page:

In the arrangement shown, as one example, graphical user interface 11 includes a home page 40 (also known as “landing page” or “interaction page” or simply “project interaction page”). Project interaction page 40 is formed of any suitable size, shape, and design and is configured to provide an overview for a project manager and/or a landing page. In this way, the home page serves as a place where a project manager and/or team member can view various projects they are managing and/or assisting with. Additionally, the page provides quick links to create additional projects and/or matters and interact generally and in various ways with the system 10, as disclosed herein.

In the arrangement shown, was one example, home page 40 includes, but is not limited to, a projects list 42, a search feature 44, a filter feature 46, a settings feature 48, a list feature 50, an approval feature 52, a roadmap feature 54, a calendar feature 56, and a main window feature 58, among other features, components and functionalities.

Project Page:

In the arrangement shown, as one example, graphical user interface 12 includes a project page 60 (also known as “project overview page” or “project search page” or simply “overview page”). Project page 60 is formed of any suitable size, shape, and design and is configured to provide an overview of past, present, and/or future projects (as filtered and/or set up for view) for a project manager and/or a project overview page. In this way, the projects overview page serves as a place where a project manager and/or team member can view various projects they are managing and/or assisting with. Additionally, the page provides quick links to create additional projects and/or matters and interact generally and in various ways with the system 10, as disclosed herein.

In the arrangement shown, was one example, project page 60 includes, but is not limited to, a select project feature 62, a project number identifier 64, a filter feature 66—for filtering projects shown in the window, a status feature 68, a title feature 70, an identifier code 72, a spec implementer identifier 74, a state of project feature 76, a points indicator 78, a percentage finished indicator for project feature 80, an interactive progress bar 82, percentage project complete indicator 84, color indicator 86, percentage finish indicator task 88, progress bar 90, percentage complete indicator 92, color feature 94, priority order indicator 96, hover feature 98, plurality of information features 100, date indicator 102, percentage finish indicator 104, past indicator 106, present indicator 108, future indicator 110, hourly view feature 112, daily view feature 114, weekly view feature 116, monday percent complete indicator 118, tuesday percent complete indicator 120, wednesday complete indicator 122, thursday complete indicator 124, a friday complete indicator 126, and a unfinished percentage indicator 128, among other features, components and functionalities.

View Page:

In the arrangement shown, as one example, graphical user interface 11 includes a view page 130 (also known as “daily view page” or “weekly view page” or “monthly view page” or “yearly view page” or simply “view page”). View page 130 is formed of any suitable size, shape, and design and is configured to provide a manager and/or other user with a quick overview of daily progress. In this way, the view page 130 provides the manager and/or other user with a feel for the project progress. In the view page 130, combined with other features in this disclosure, the manager can quickly gain an understanding of the progress a project has made, progress various users are making in their tasks, those who might be overworked, those who might be underworked and/or underperforming, those who might need additional tasks assigned, those who might need their work allocated to others, and the overall progress of various tasks, requirements, and projects. In this way, the view page 130 can provide an observer with both an overall feel of the project as well as a detailed look and/or view of the project, those involved in the project, and the various items and/or matters within a project, including but not limited to requirements, tasks and modules.

In the arrangement shown, was one example, view page 130 includes, but is not limited to, a select feature 132, a number identifier feature 134, a filter feature 136, a title feature 138, an identifier code 140, a spec owner feature 142, a state of project indicator feature 144, a progress point feature 146, a percentage finished feature 148, a select date view feature 150, and a date scroll feature 152, among other features, components and functionalities.

Roadmap Page:

In the arrangement shown, as one example, graphical user interface 11 includes a roadmap page 160. Roadmap page 160 (also known as “roadmap planning page”) is formed of any suitable size, shape, and design and is configured to provide a much improved way of project planning. In the present disclosure and as is shown in the figures, the roadmap page 160 is configured to provide a vivid and accurate project progress animation to conveniently convey to a manager and/or user how exactly a project is being implemented. In this way, the roadmap view 160 can show a manager how the project is progressing and the path to the completion of the project, the parties involved, and the like.

In the arrangement shown, was one example, roadmap page 160 includes, but is not limited to, a year selection feature 162, a quarter selection feature 164, a month selection feature 166, a week selection feature 168, a day selection feature 170, a project selection feature 172, a task selection feature 174, and a module selection feature 176, among other features, components and functionalities.

Requirement Pulse:

In the arrangement shown, as one example, system 10 includes a requirement pulse 200 (also known as “project pulse” or “project feel” or simply “pulse”). Requirement pulse 200 is formed of any suitable size, shape, and design and is configured to provide a framework which defines both a method and means of visualizing the development of a project and/or the implementation of a project. In this way, a manager and/or user can view the requirement pulse 200 and clearly understand the project progress at the requirement level and how the requirement level reflects on the progress of the project as a whole. Said another way, the requirement pulse 200 displays the effort and progress of a project which are made at the task level, which further conveys the overall effort and progress being made on a project.

In the arrangement shown, as one example, requirement pulse 200 defines the business needs of a project and displays these needs to a manager and/or user viewing the requirement pulse 200. Furthermore, the requirement pulse 200 defines and conveys how a requirement is being implemented or how a requirement is not being implemented. Said another way the requirement pulse 200 represents the actual work that a project team member needs to spend time on to deliver the project. From a different perspective, the requirement pulse 200 will convey to a manager where the manager should focus attention and/or focus the efforts of the managers developers so that the project can progress.

In this way, and to achieve conveying the feel and/or status of a project to a manager, the requirement pulse 200 displays and instructs to a manager the project progress at the requirement level. Furthermore, in this way and by displaying the project progress to a manager at the requirement level, the manager and/or observer can instantly understand a more optimized way of managing a project, and subsequently implement this optimized way of completing the project.

In this way, and to achieve these representations, the requirement pulse gathers information constantly, at the requirement level, from various aspects of the project and from all of those involved within a project. The requirement pulse 200 collects data from a plurality of developers on the various matters they are working on and can instantly display this information to a manager. The manager is also enabled, by the requirement pulse 200 to see past progress, hours spent on a requirement, historical hours spent on historically similar requirements, the duration of how much time a certain developer spends on this type of requirement, display current amount of time spent on the requirement, and even predict the overall amount of time which will be spent on the requirement. Overall, these impressions among others can quickly display to an observer the status of a requirement and the pulse of a project.

In the arrangement shown, as one example, the spec item is quantified to aid in achieving the requirement pulse 200 understanding. In this way, the amount of time required to implement a function is provided. Furthermore, the time spent and the time remaining for all the tasks in the effort of a developer to implement a requirement are accumulated to and calculated by the requirement formula and converted into a percentage (for ease of understanding) of the development work done for each requirement at any given time.

In other words, the requirement pulse 200, along with other features and functionalities of system 10, creates a project planning environment in which project implementation efforts are estimated both at the requirement level and the task level. At the requirement level, spec points 203 for each requirement are estimated by the manager and/or users to represent the amount of hours required to implement a requirement.

Once the amount of hours are estimated, the quantifying implementation effort of the requirement pulse 200 at the requirement level provides independent time estimates for project implementation details based on historical data, developer data, and other inputs provided by the manager and other parties involved. Additionally, the requirement pulse 200 at the requirement level provides an easy and clear calculation of the amount of work required for each requirement. Additionally, the requirement pulse 200, at the requirement level, provides project managers and/or other users and/or owners of a project the ability to estimate project cost. Additionally, and in this way, the requirement pulse 200 can provide a total project cost estimate and weigh this total cost estimate against an engineering based cost estimate and provide this information to the manager for the project implementation cost. In this way, the requirement pulse 200 can also help a manager and/or owner and/or other user determine project feasibility and benefit (which may determine the undertaking of a project prior to start).

Furthermore, with the requirement pulse 200 quantifying these various quantities and with the requirement pulse 200 linked to actual implementation tasks, the requirement percentage to finish the project can be calculated showing daily calculations, weekly calculations, quarterly calculations, yearly calculations, and the like.

Furthermore, and as is shown in the figures as an example, the requirement pulse 200, showing in a percentage of completion, can be displayed graphically to illustrate project requirement percentage, project finish percentage progress, and the like. Such requirement level calculations, such as finish percentage, and displaying this finish percentage as a graphic creates and/or generates a requirement pulse 200 to a user, such that the user can clearly have a “feel” for a project.

In the arrangement shown, was one example, requirement pulse 200 includes, but is not limited to, a plurality of requirements 202, a plurality of spec points 203, an implementation module 204, a plurality of tasks 206, a plurality of developers 208, a quantification feature 210, a quantification formula 211, a points assignment feature 212, a percent calculator feature 214, and a finish calculator feature 216, —as well as other components of the system 10 which aid a user and/or manager in gaining understanding in a project and the various aspects associated with a project—among other features, components and functionalities.

Task Points:

For clarity, task points are discussed further. Specifically, in the arrangement shown, as one example, system 10 includes task points. Task points are formed of any configuration, calculation, specification, as desired and are configured to provide a measurement for the difficulty and/or time expected on a task. Task points (also referred to as “Spec Points”, or “Module Points”, or simply “Points”) are used for calculating the percent finish at the task level.

In the arrangement shown, as one example, “task points” is a term generally used to describe what assignments expect the difficulty to be. While “spec points” is a term generally used from a management and/or project owner perspective on what the owner and/or manager believes the time and/or difficulty is. Furthermore, while the terms are used interchangeably on occasion, “module spec points” is the term generally used to describe (at least initially) what management thinks a module will take. Following management assigning module spec points, management will create a task for each module. The spec points are then broken into task points (i.e. the points at the task level are always task points and typically show a summation of task points equal to the spec points assigned to a given module). However, the developer and/or assignee can increase and/or decrease the task points to indicate that the initial spec point estimation is incorrect (i.e. if the summation of the task points are over spec points for a given module then the initial estimation by management is incorrect and underestimated. Similarly, if the summation of task points are under spec points for a given module, then the initial estimation was overestimated.)

In the arrangement shown, as one example, the module points are configured to determine the size and/or difficulty of the task. Similarly, the spec points are configured to determine and communicate the time it may take for a task to be completed. In this way, the spec points are utilized for calculating the percent finish at the task level. Similarly, in this way, the spec points are used as the weight for tasks and/or requirements.

In one example of task points, and strictly for example, a requirement (Requirement A) may have the following two modules. Said another way, in order for the requirement to be completed, both modules and therefore all tasks within the modules must be completed:

Module 1-8 total spec points including 2 tasks (Task 1 and Task 2) in the module. Task 1 may be more difficult and be estimated to take 6 hours to complete. Thus, in this example, the expectation is that Task 1 will take about 6 hours to complete. Similarly, in this time based example, Task 2 is expected to take about 2 hours to complete. Thus, Task 1 is assigned 6 spec points while task 2 is assigned 2 spec points. In total, the tasks of module 1 will equal task 1 (6 spec points) plus task 2 (2 spec points) for a total of module 1 having 8 spec points. This total spec point gives all involved an idea of how long and/or how difficult the module is to complete. Time and the like can be allocated accordingly.

Module 2-4 total spec points also including 2 tasks (Task 3 and Task 4) in the module. Task 3 and Task 4 may have a similar expected difficulty and/or be estimated to take 2 hours to complete. Thus, in this example, the expectation is that Task 3 will take about 2 hours to complete. Similarly, in this time based example, Task 4 is expected to take about 2 hours to complete. Thus, Task 3 is assigned 2 spec points while task 4 is assigned 2 spec points. In total, the tasks of module 2 will equal task 3 (2 spec points) plus task 4 (2 spec points) for a total of module 2 having 4 spec points. This total spec point gives all involved an idea of how long and/or how difficult the module is to complete. Time and the like can be allocated accordingly.

However, the assignee may believe that Module 2 is underestimated and will take more time than allotted by the manager. In this example, Module 2 may ultimately take 5 hours to complete instead of the total estimated 4 hours. Furthermore, it is Task 4, in this example, that is more difficult. For example, Task 4 actually takes 3 hours to complete and/or 3 task points.

In the example, where Task 4 is underestimated, there are two methods of examples of how this overage is calculated for the requirement pulse and/or percent finished. In one example, a weighted option and a non-weighted option might be used for the calculation of the requirement pulse.

In the arrangement shown, as one example, a manager will assign spec points. In some arrangements, an assignee may accept the amount of spec points assigned, may warn the manager it will take longer, or simply enter extra time. Furthermore, an assignee can also request the spec points be changed (increased and/or decreased). In yet another example, some assignees and/or all assignees may have the ability to change spec points before, during, or after the task is completed.

Application Server:

In the arrangement shown, as one example, system 10 may comprise remote servers 620, databases, and/or computers 640 that fulfill the functions disclosed and described herein. In the embodiment depicted, system 10 comprises an application server 600. Application server 600 comprises one or more computer systems adapted to transmit and receive data regarding selected datasets related to various users and/or datasets related to multiple users. Application server 600 is adapted to a query database with unique identification codes to retrieve project information and/or parameters related to users, projects, items, subcontractors, cost codes, inspectors, hours, and more.

Application server 600 may transmit user data related to layers and rules with respect to a single user and/or multiple users. Application server 600 is also adapted to query a user database 14. This query includes receiving and sending user identification codes and user data. Additionally, the application server 600 may communicate with a mobile application 608, which is adapted to present the user information in a form conducive to being viewed on a mobile device and/or handheld device.

As one of ordinary skill in the art may understand, application server 600, project database 602, and other databases mentioned herein may be implemented in one or more servers. Furthermore, each may be on multiple servers to increase system efficiency, especially when handling large data gathering, data organizing, such as handling global positioning of a user, following extended rules for various functionality of system 10 and/or processing, updating user information, including various quantities entered.

Additionally, multiple servers may have mirrored data to prevent data loss in case of disk failure and/or to decrease access and response times for database queries. In alternative embodiments, application server 600, and other database procedures may be carried out on computer-readable instructions and data stored on the customer's mobile computing device.

Additionally, system 10 may include a remote server 620, a computing system 640, includes an application programming interface 700 (“API”) which includes tools and resources enabling a user to operate the embodiments herein, and a cloud computing system 720.

Computing System 640:

In one arrangement, as is shown, smart device and/or system 10 includes computing system 640. Computing system 640 is formed of any suitable size, shape, and design and configured to handle computing operations, as are necessary for the operation of the computing functionality of system 10. Computing system 640 is connected with electronic network and/or database and/or server or cloud via communication means and includes a processor 643, a memory 644, a microcontroller 645, a printed circuit board 646, a microprocessor 648, a receiver/transceiver 649, may include at least one antenna 650, among other components.

Computing device 640 may be formed of any computing device capable of displaying and manipulating data in the manners described herein. Computing device 640 may include for example a desktop computer, a laptop computer, a tablet, smart phone, or any other computing device or other interactive device.

Computing device 640 may be a single consolidated component, or alternatively, computing device 640 may be formed of a plurality of interconnected components that may be co-located or located at different geographic locations. Computing device 640 may be cloud based or it may be hardware based, or cloud capable. In addition, the connected components of computing device 640, including processor, memory, software and interactive user display, may be co-located with computing device 640 or located at different geographic locations. That is, computing device 640 may be made of any form of a device or system that individually or collectively performs the computing operations of system 10.

Printed Circuit Board: In the arrangement shown, as one example, system 10 includes a printed circuit board 646 (“PCB”). PCB 646 is formed of any suitable size, shape and design and is configured to facilitate carrying and/or holding other components and/or parts necessary to carry out various computation and/or related functions of system 10. PCB 646, as one example, might be a surface mounted PCB or a through-hole PCB. PCB 646, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB 646.

Microprocessor: Microprocessor 648 is any computing device that receives and processes information and outputs commands according to instructions stored in memory 644. Memory 644 is any form of information storage such as flash memory, RAM memory, a hard drive, or any other form of memory. Memory may be included as a part of or operably connected to microprocessor 648. A receiver/transceiver 649 is connected to microprocessor 648. A receiver is used if one way communication is utilized, whereas a transceiver is used if two-way communication is utilized (hereinafter “transceiver”).

Memory: In the arrangement shown, as an example, system 10 includes a memory 644. Memory 644 may be formed of any suitable size, shape and design and is configured to facilitate selective storage and retrieval of data (including data) in association with computing device 640, processor, software and interactive user display. Memory 644 may be a single component, such as a single chip or drive or other memory device, or alternatively memory may be formed of a plurality of memory or storage components that are connected to one another that may be co-located or located at different geographic locations.

### ALTERNATIVE EMBODIMENTS

In another embodiment, as shown in one example, the project pulse features enables a user and/or manager and/or owner to easily determine the percent of a project completion on a daily basis. Similarly, the project pulse features enables a user and/or manager and/or owner to easily determine the percent of a project completion on a weekly basis. Similarly, the project pulse features enables a user and/or manager and/or owner to easily determine the percent of a project completion on a monthly basis. Similarly, the project pulse features enables a user and/or manager and/or owner to easily determine the percent of a project completion on a yearly basis. Similarly, the project pulse features enables a user and/or manager and/or owner to easily determine the percent of a project completion on a task basis. Similarly, the project pulse features enables a user and/or manager and/or owner to easily determine the percent of a project completion on a requirement basis.

Hover feature: In the arrangement shown, as one example, system 10 includes a hover feature. Hover feature is formed of any suitable size, shape, and design and is configured to provide additional information when a user hovers over information. Particularly, and in the arrangement shown, as one example, a user can hover the mouse or cursor over the project pulse and/or completion percentage and receive instant information related to how that particular percentage has been completed. Furthermore, a user can hover over the project pulse and get instant feedback on what has been completed on the project and/or requirement, as well as, view other notes related to particular tasks and the like.

Notes Feature: In the arrangement shown, as an alternative embodiment, a notes feature is included. The notes feature allows a developer to enter in notes associated with a given requirement and/or task. These notes may be required. Furthermore, the notes entered by the developer can provide instant feedback and/or other information related to a particular requirement and/or task to the manager and/or owner and/or other users, such as other users which may be working on a particular project, a particular task and/or a particular requirement. Similarly, the notes feature may be utilized to provide information on a completed task or how part of a task has been accomplished.

Agile Feature: In the arrangement shown, as an alternative example, system 10 includes an agile feature. Agile feature is formed of any suitable size, shape, and design and is configured to provide quantification of a task and/or requirement size. In the arrangement shown, as one example, this quantification of a task and/or requirement size is completed by assigned a number. The number correlates with the number of hours a task and/or requirement is expected to take a single developer. However, in another embodiment and/or an alternative embodiment, the agile feature may correlate to a number of developers and/or a number of hours and a number of developers and/or other information related to a task and/or requirement to convey information associated with a particular task and/or requirement. In one arrangement, after an owner assigns a requirement and/or a task to a developer, the developer will enter a number into the agile feature which states the number of hours and/or amount of time the developer expects it to take for the task and/or requirement to be completed. This number may also be a number of days, or weeks, or months, or years, or all of the above. Furthermore, this may be done by a single developer for a number of tasks and/or requirements. Furthermore, this is a means for helping a manager determine for future reference how much time similar tasks might take. Furthermore, the system will learn how long particular tasks and/or requirements will take based on previous time entries in associated tasks (these time entries being actual time entries entered by developers, as opposed to estimates). In this way, system 10 can learn time expectations for different types of tasks and/or requirements and/or requirements for a parent task, in calculating a task based on understanding of time it will take to complete particular requirements assigned within a given task.

Time Entry: In the arrangement shown, as one example, system 10 includes a time entry and/or time log system. In this way, every task and/or requirement provides for time entry to be completed. All developers must enter time spent on a given task and/or requirement. In this way, a developer can track time related to and/or invested in a particular task and/or requirement. In this way, both developers and/or administrators and/or managers can see how much time has been spent on a task, how much time a requirement may require for completion, and determine if more assistance is needed on a given task and/or determine if a task and/or requirement is on schedule, amongst making many other determinations.

Developer Productivity Analysis: In the arrangement shown, as one example, system 10 also includes a productivity analyzer. Productivity analyzer is formed of any suitable size, formula, and allowed to accept various variables. Productivity analyzer is configured to accept information related to a task and/or requirement and see how successful a given developer is at completing such a task. In this way, system 10 can learn through sets of rules and the like where and when to assign tasks and/or requirements. For example, system 10 can determine which tasks are similar and how long particular tasks take to complete. System 10 can further determine through data entry and a predetermined set of rules how long a particular developer takes to complete a particular task and/or requirement. For example, if most developers complete a particular task within 10 hours, but developer A completes this particular task and/or related tasks in only 7 hours on average, then the system will assign the particular tasks and/or related tasks to this particular developer when developer A is ready for assignments. Furthermore, the developer productivity analyzer can work in concert with a manager by providing this type of information to the manager and/or owner and allowing the owner the ability to see and quickly analyze where to assign tasks and the like based on related information. In this way, the more tasks completed and the more developers, the more the system will learn about task completion times and assignments and the like. In this way, predictions of dates for completion and progress can be learned over time by the system and/or a manager and/or owner.

Requirement Points: In the arrangement shown, as one example, system 10 also includes requirement points. Requirement points are certain checkpoints and/or completion designations for a developer to mark and/or notify system 10 of. These checkpoints further breakdown tasks and/or requirements for clarity in how complete a particular task and/or requirement is and further provide additional information and variables associated with task assignment and the like.

Gamification: In the arrangement shown, as one example, system 10 includes a positive reinforcement and/or feedback system designed and configured to provide rewards and the like for hard work. In the arrangement shown, as one example, the system may provide badges or other positive feedback for when a developer completes a task and/or requirement within a set time. Furthermore, the system may provide other positive feedback and the like for various parameters such as when a developer completes so many hours of work, or completes a particular number of tasks and/or requirements in a certain time period. In this way, both fictional and real positive feedback can be provided. This may be a badge that is attached to a user profile. This may be an alarm or alert to a manager to congratulate and/or provide positive feedback to a developer. This award may also be a real reward such as a gift card, a bonus, a vacation, or the like.

In Operation:

As one example, and in the arrangement shown, system 10 is designed to provide a project management system. These operations of the system and various methods of use are hereby contemplated for use and/or disclosed herein.

In one example, and as shown in the figures, a manager can implement the disclosure herein in order to visualize how a project has been implemented for a set of requirements by the project team and/or parties involved in the project. Furthermore, in this way, a manager can select a project requirement folder, and further select the project pulse calendar control, scroll through various dates into the past, present, or future, and the project pulse will graphically show how each requirement of the project is being implemented by the project team.

In this method of use, and unlike anything in the art, the project pulse picture created shows a roadmap for project planning. This provides a vivid and accurate animation of how the project can be best implemented.

As another example, and in the arrangement shown, system 10 is designed to provide a project pulse. These operations of the project pulse within system 10 and the various methods are hereby contemplated for use.

In this method, and in one example, the method herein is implemented on at least one machine and/or computer processing unit having at least one processor, storage, and a communication platform connected to a network for information sharing and interaction between users.

The project sharing, project viewing, project uploading, and project downloading may include a plurality of controllers that routinely request input from a user and/or updates to information provided and stored in databases. In this way, a user and/or manager can view various data as it is uploaded, stored, converted, and additionally view subsequent data generated by the processors of system 10 to perform the functions herein.

In this example, different contributors, such as developers, can share their progress which will be shared with a database. The progress information can be used to update the project information also stored in the database. The information, both raw and converted, can then be accessed and viewed by a manager anywhere.

Requirement Pulse Logic:

In the arrangement shown, as one example, the time required to implement a requirement is calculated by breaking the requirement down into implementation modules (areas of work). The modules, generally, are implementation components of a larger project. A requirement may need implementation efforts for one, many, or all modules. A development task is created for a specific implementation module. Completion of these tasks and eventually completion of all related modules means the requirement is complete.

In an alternative embodiment, requirement progress can be accurately gauged even when the requirement is broken down into tasks without modules. However, in the arrangement shown, the requirement is broken down with modules for ease of explanation and ease of calculation, such that the requirement progress can be accurately gauged. In this alternative embodiment and in some instances, tasks without modules, may mean that 1) tasks have not yet been created.

In the arrangement shown, as one example, the percentage finish of a requirement is based on the percentage finish of its modules. In this way, and because modules vary by size (difficulty—often rated by project managers), the modules weight must be accounted for. For example, two modules of varying difficulty, means that completion of one of the two modules, does not equal 50% percent completion of the requirement. In this system, the truer completion percentage is captured based on appropriate size, and specification points which are assigned to the modules. These specification points are distributed to the modules with more points given to larger and/or more difficult modules to complete. Oftentimes, more points equates to more hours, and the like required to complete a requirement.

### EXAMPLE

A requirement may have two modules. The total requirement is 10 spec points.

Module 1 (i.e. server development work) is 8 spec points.

Module 2 (i.e. GUI development work) is 2 spec points.

Completion of module 1 with no progress on module 2 means 80 percent finish for the requirement.

In this way, the percentage finish of a module is derived from the percentage finish per task that is assigned to the module. In this way, the percentage finish is calculated from the time remaining and time spent for all the tasks for a given module. The following are examples, and only example, of representation of two methods of calculation of the percentage finish of a module based on the tasks finished for a requirement. The following are meant as contemplations for use but are in no way imitating on how percentage finish might be calculated for a module.

### Example 1

Example 1, as one example, is based purely on total time spent as weighted against the time remaining for all tasks assigned for a corresponding module. In this example, the percentage finish of a requirement for any date can be calculated using the following formulas:

Past and Current Date Formulas:

% finish of a task=time spent up to that date/total time (time spent up to that date+time remaining/planned).

Future Date Formula:

% finish of a task on a future date=time spent and planned up to that future date/total time (total time spent up to that date+total time remaining/planned).

% finish of the corresponding module=total time spent for all related tasks/total time (time remaining+time spent) for all related tasks.

Where T represents task and n represents the number of tasks for this module.

% finish of a requirement=[(% finish for M1*Spec point for M1)+(% finish for M2*spec point for M2)+ . . . +(% finish for Mn*spec point for Mn)]/Total Spec Points.

Where M represents module and n represents the number of modules.

### Example 2

This example is based on % finish of each task weighted by its task points. In this approach, and in this example, the percentage finish of a requirement for any date can be calculated using the following formula:

Past and current date:

% finish of a task=time spent up to that date/total time (time spent up to that date+time remaining/planned).

Future date:

% finish of a task on a future date=time spent and planned up to that future date/total time (total time spent up to that date+total time remaining/planned).

% finish of the corresponding module=[(% finish T1*task point for T1)+(% finish T2*task point for T2)+ . . . +(% finish Tn*task point for Tn)]/by total task point.

Where T represents task and n represents the number of tasks.

% finish of a requirement=[(% finish for M1*Spec point for M1)+(% finish for M2*spec point for M2)+ . . . +(% finish for Mn*spec point for Mn)]/Total Spec Points.

Where M represents module and n represents the number of modules.

In these examples, tasks are worked on per day and have an end date. However, tasks are not required to have an end date. Calculations with an end date tend to provide ease in calculations. This also allows for daily progressions to be tracked and displayed by the present system.

In the arrangement shown, as one example, the requirement pulse and/or project pulse can display and/or be used to visualize the requirement level. Similarly, the requirement pulse and/or project pulse can display and/or be used to visualize the requirement pulse—the progression of completion, for the past, present, and the future.

In this way, the present disclosure provides the state of the art with a requirement pulse. The requirement pulse provides many benefits such as improved project management, improved project clarity, increased productivity corresponding to self-driving teams, increased productivity related to clarity in existing project completion finish percentages, decreased costs associated with project management, and the creation of a sound and efficient method of agile project planning—eliminating and/or nearly eliminating overhead work needed in creating an accurate project development plan. Similarly, the agile planning does not require constant and time consuming project planning change and approval process management work.

This compares to traditional project planning, or project planning involving breaking a project down utilizing WBS (work breakdown structure). This means that there will always be a project manager (or many) utilizing Gantt charts to view and set start and end dates for all work items of the project. It requires constant effort from management to make sure the established plan is followed and is expensive and not representative of what the team is doing. The present disclosure solves this problem and others.

In one example, and as another benefit over the existing art, the present disclosure contradicts with traditional planning as things are constantly shifted instead of following a WBS project plan. For example, if project requirements are committed on a monthly basis (roadmap months), that means there is no need to set hard start and end dates. Therefore, the present disclosure eliminates the need for project managers to plan and scope out entire projects. The project pulse then becomes immensely useful as management can always see the reality of what the team is doing and capable of doing resulting in much better project planning and management.

As yet another added benefit, the present disclosure provides self-driving teams. More specifically, spec points (estimates by product owners or product managers responsible for project scope and budgeting) vs task points (estimates by the development teams) are used, which causes constant conflict between the two to synchronize and feedback to each other to determine if the right estimates are used and what is the best way to complete the project. The present disclosure eliminates the one-sided approach where management decides the entire project plan.

With the present disclosure, the project pulse, the data collection is automatic—and/or completed by a predetermined set of rules, from teams logging in time for their activities. In this way, the data and percentage complete is always correct so there is no need to do traditional planning with start and end dates. Work no longer needs to be broken down just for project planning purposes.

In this way, the present system, the project pulse, provides a means for management to predict what may happen within the next month. In this way, the present disclosure more accurately provides delivery dates of tasks and/or requirements to managers. This is extremely beneficial for the business and project management, such as sales and planning product launches, and more. This is an area where traditional WBS fails or can't do since it's a one-sided approach that does not foresee delays. More time is allocated for the plan upfront to account for delays.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A system for project planning, comprising:
a plurality of projects;
each of the plurality of projects having a plurality of requirements;
each of the plurality of requirements having a plurality of modules;
spec points;
a manager;
wherein the manager assigns a spec point having a valuation to each of the plurality of modules;
wherein the manager sorts each of the plurality of modules as they relate to each of the plurality of requirements;
wherein the manager sorts each of the plurality of requirements by assigning to a plurality of assignees;
wherein each of the plurality of assignees enters time worked on each of the plurality of modules at regular time intervals;
a writer;
the writer having a predetermined set of rules;
wherein the predetermined set of rules calculates a percentage finish of each of the plurality of modules based on the time worked on each of the plurality of modules;
a requirement pulse;
wherein the requirement pulse displays an indicator based on the percentage finish;
wherein the requirement pulse updates automatically when time is entered by any of the plurality of assignees working on the module associated with the requirement pulse.

2. The system of claim 1, further comprising:
wherein the manager can determine the availability of the team to accept the plurality of requirements based on an indicator.

3. The system of claim 1, further comprising:
wherein the plurality of assignees are developers.

4. The system of claim 1, further comprising:
Wherein the spec points are associated with an amount of time it is expected the requirement to take to be completed.

5. The system of claim 1, further comprising:
Wherein the spec points are associated with a difficulty level associated with the requirement.

6. The system of claim 1, further comprising:
a queue;
wherein the queue presents the availability of the team to accept the plurality of tasks based on the indicator;
wherein the queue populates a priority order for an assignee with the highest availability of time to accept the plurality of tasks based on the indicator.

7. The system of claim 1, further comprising:
a queue;
a plurality of tasks associated with a plurality of requirements;
wherein the manager assigns the plurality of tasks to a plurality of assignees with the highest availability of time to accept the plurality of tasks.

8. The system of claim 1, further comprising:
wherein the indicator of the requirement pulse displays a percentage of finish.

9. The system of claim 1, further comprising:
wherein each of the spec points represents an amount of time expected for completion.

10. The system of claim 1, further comprising:
each of the plurality of tasks assigned to each of the plurality of modules.

11. The system of claim 1, further comprising:
a platform;
the platform having a graphical user interface;
the platform having a sub-platform;
the sub-platform having a queue and a writer;
wherein the manager adds the plurality of tasks to the queue;
wherein the writer autonomously assigns the plurality of tasks based on the queue and availability of the team, as indicated by the indicator.

12. The system of claim 1, further comprising:
a graphical user interface;
the graphical user interface having a login feature;
the graphical user interface having an accounts feature;
the graphical user interface having a home page feature;
the graphical user interface having a project feature;
the graphical user interface having a daily view feature;
the graphical user interface having a roadmap feature.

13. The system of claim 1, further comprising:
the requirement pulse associated with a plurality of task requirements;
the requirement pulse associated with a plurality of specification points;
the requirement pulse associated with at least one implementation module;
the requirement pulse associated with a plurality of tasks;
the requirement pulse associated with a quantification feature;
the quantification feature having a quantification formula.

14. The system of claim 1, further comprising:
a finish timeline calculator;
wherein the finish timeline calculator provides an estimated date of completion of the requirement.

15. The system of claim 1, further comprising:
a percentage completed calculator;
wherein the percentage completed calculator provides the manager with a quick view of the percentage of a current task completed.

16. A system for project planning to easily understand progress of a task, the system comprising:
a project pulse feature;
the project pulse feature having a plurality of associated tasks;
wherein each of the plurality of associated tasks is assigned a value of task points;
the project pulse feature having a time spent;
the project pulse feature having a time remaining feature;
the project pulse feature having a percent finish feature;
wherein the percent finish feature displays the completion percentage of a task.

17. The system of claim 16, further comprising:
wherein the percent finish feature is calculated by time spent against the time remaining for each of the plurality of associated tasks.

18. The system of claim 16, further comprising:
wherein the percent finish feature is calculated based on a weighted calculation of the value of tasks points of each of the plurality of associated tasks.

19. The system of claim 16, further comprising:
a plurality of projects;
each of the plurality of projects having a plurality of requirements;
each of the plurality of requirements having a plurality of modules;
spec points;
a manager;
wherein the manager assigns a spec point having a valuation to each of the plurality of modules;
wherein the manager sorts each of the plurality of modules as they relate to each of the plurality of requirements;
wherein the manager sorts each of the plurality of requirements by assigning to a plurality of assignees;
wherein each of the plurality of assignees enters time worked on each of the plurality of modules at regular time intervals;
a writer;
the writer having a predetermined set of rules;
wherein the predetermined set of rules calculates a percentage finish of each of the plurality of modules based on the time worked on each of the plurality of modules;
a requirement pulse;
wherein the requirement pulse displays an indicator based on the percentage finish;
wherein the requirement pulse updates automatically when time is entered by any of the plurality of assignees working on the module associated with the requirement pulse;
a requirement pulse display;
wherein the manager can view the availability of the plurality of assignees and track progress of the plurality of projects by viewing the requirement pulse display;
an assignee interface;
wherein the assignee interface provides a means for each of the plurality of assignees to manage and organize each of the plurality of tasks which have been assigned to each of the plurality of assignees.

20. A method of determining and tracking task requirements, the steps comprising:
displaying on a graphical user interface a project management system;
populating the project management system with a plurality of projects and requirements for each of the plurality of projects;
assigning a spec point value to each of a plurality of modules;
assigning each of the plurality of modules to the requirements for one of the projects of the plurality of projects;
assigning the requirements to a plurality of assignees;
entering time worked on a given requirement by each of the plurality of assignees;
determining by a predetermined set of rules a percent finished, using time worked against total time expected;
Displaying the percent finished in a requirement pulse.
